(19) United States
(12) Patent Application Publication
(10) Pub. No.: US 2026/0264417 A1
(43) Pub. Date: Sep. 10, 2026

(54) INFORMATION PROCESSING APPARATUS, INFORMATION PROCESSING METHOD, AND NON-TRANSITORY COMPUTER-READABLE STORAGE MEDIUM STORING COMPUTER PROGRAM

(71) Applicant: SEIKO EPSON CORPORATION, Tokyo (JP)

(72) Inventors: Shuhei KAWASE, Shiojiri-shi (JP); Masaki MARUNO, Shiojiri-shi (JP)

(73) Assignee: SEIKO EPSON CORPORATION, Tokyo (JP)

(21) Appl. No.: 19/554,835

(22) Filed: Mar. 3, 2026

(30) Foreign Application Priority Data
Mar. 4, 2025 (JP) 2025-033402

(51) Int. Cl. B41J 3/407; B41J 11/58; B41J 11/70

(52) U.S. Cl. CPC B41J 3/4075; B41J 11/58; B41J 11/703

(57) ABSTRACT

Provided is an information processing apparatus generating printing information to be transmitted to a printing apparatus, which includes a tape roll holding mechanism to which a plurality of types of tape rolls wound around cores and having different widths are selectively attached and a head that performs printing on tape of the tape roll, the information processing apparatus including an input section and a controller. The controller executes, with respect to printing target information representing a target to be printed, a target adjustment process including correction regarding a dimension in a width direction when (i) a second type tape roll narrower than a first type tape roll, which is a widest tape roll attachable to the tape roll holding mechanism, is attached to the tape roll holding mechanism and (ii) an instruction to perform the correction with respect to the printing target information is received via the input section.

The present application is based on, and claims priority from JP Application Serial Number 2025-033402, filed Mar. 4, 2025, the disclosure of which is hereby incorporated by reference herein in its entirety.

### BACKGROUND

### 1. Technical Field

The present disclosure relates to an information processing apparatus, an information processing method, and a non-transitory computer-readable storage medium storing a computer program.

### 2. Related Art

In the related art, there is a thermal printer that performs printing on a plurality of types of tape having different widths. A thermal printer of US 2024/0308802 includes a first paper blocking plate and a second paper blocking plate. The first paper blocking plate and the second paper blocking plate move symmetrically in directions toward each other and in directions away from each other via a ratchet. The first paper blocking plate and the second paper blocking plate come into contact with both end surfaces of label paper wound around a core and having a cylindrical shape, to hold the label paper. As a result, the thermal printer can hold the plurality of types of label paper having different widths at an accurate position in a direction along an axis around which the label paper is wound.

However, a mechanism as in US 2024/0308802 has a complicated configuration. Therefore, in the case of the printer of US 2024/0308802, it is difficult to reduce the manufacturing cost. As an aspect in which the mechanism as in US 2024/0308802 is not provided, an aspect is conceivable in which the position of tape serving as the label paper is maintained in a direction along an axis, around which the tape is wound, by means of a frictional force between a supporting shaft and an inner surface of the core, the supporting shaft supporting a core of the tape by being inserted into the core. However, in such a case, when the wound tape is drawn out and transported, the core of the tape may be shifted with respect to the supporting shaft, which may cause a positional shift in a width direction of the tape. When the tape is shifted with respect to a printing head to the outside of an area in which printing is scheduled to be performed, a target to be printed is not printed on the tape.

### SUMMARY

According to an aspect of the present disclosure, there is provided an information processing apparatus generating information used to cause a printing apparatus to perform printing. The printing apparatus includes a tape roll holding mechanism to which a plurality of types of tape rolls wound around cores having inner diameters determined in advance and having different widths are selectively attached and that holds an attached tape roll and a head that performs printing on tape of the attached tape roll. The information processing apparatus includes an input section for reception of information, a communication section that communicates with the printing apparatus, and a controller that controls the information processing apparatus. The controller executes, with respect to printing target information representing a target to be printed on the tape of the tape roll attached to the tape roll holding mechanism, a target adjustment process including correction regarding a dimension in a width direction of the tape when (i) a second type tape roll having a width smaller than a width of a first type tape roll, which is a widest tape roll attachable to the tape roll holding mechanism, is attached to the tape roll holding mechanism and (ii) an instruction to perform the correction with respect to the printing target information is received via the input section.

### BRIEF DESCRIPTION OF THE DRAWINGS

FIG. 1 is an explanatory diagram showing a printing system of the present embodiment.

FIG. 2 is a perspective view showing a printing apparatus of the present embodiment.

FIG. 3 is a plan view of a head.

FIG. 4 is an enlarged perspective view showing a configuration in the vicinity of a tape roll holding mechanism.

FIG. 5 is an enlarged perspective view showing a configuration in the vicinity of the tape roll holding mechanism.

FIG. 6 is a flowchart showing a process in the printing system.

FIG. 7 is a diagram showing a screen displayed on an input section in step S100.

FIG. 8 is a diagram showing a screen displayed on the input section when the width of tape attached to the tape roll holding mechanism is designated.

FIG. 9 is a diagram showing a screen displayed on the input section when a user interface is tapped.

FIG. 10 is an explanatory diagram showing a relationship between tape and a printing region.

FIG. 11 is an explanatory diagram showing a target printed at an ideal position on the tape.

FIG. 12 is an explanatory diagram showing how the result of printing of the target is when the tape is transported with the tape being shifted to one side with respect to the head by an amount close to a maximum expected deviation.

FIG. 13 is an explanatory diagram showing the target printed on the tape when the tape is transported with the tape being shifted to the other side with respect to the head by an amount close to the maximum expected deviation.

FIG. 14 is an explanatory diagram showing a case where printing with a background pattern is executed.

FIG. 15 is a flowchart showing a process in a printing system according to a second embodiment.

FIG. 16 is a diagram showing a width table held by a controller.

### DESCRIPTION OF EMBODIMENTS

### A. First Embodiment

### A1. Configuration of Printing System

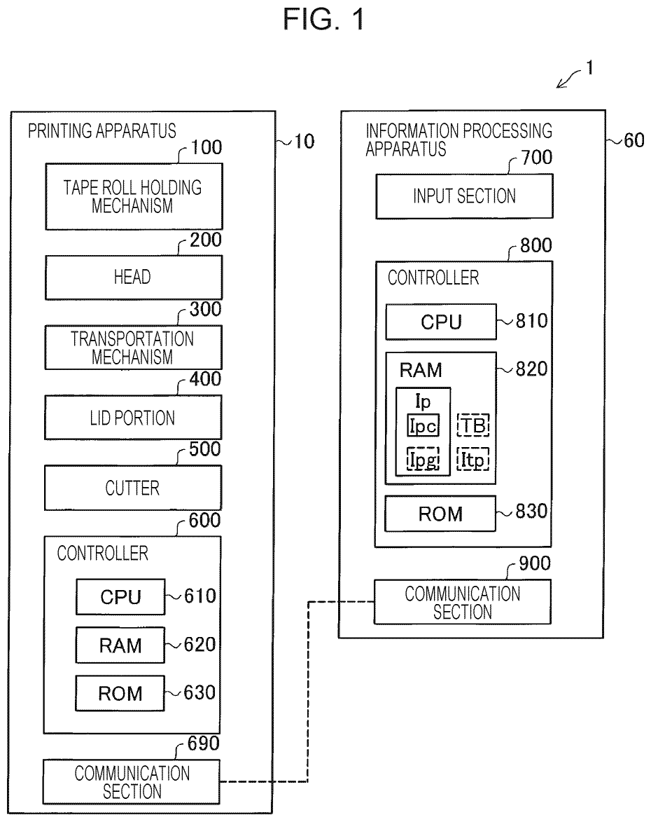

FIG. 1 is an explanatory diagram showing a printing system 1 of the present embodiment. The printing system 1 can perform printing on a plurality of types of tape rolls having different widths, the tape rolls being wound around a core having a certain inner diameter determined in advance. The printing system 1 includes a printing apparatus 10 and an information processing apparatus 60.

The printing apparatus 10 performs printing on predetermined two types of tape rolls TR1 and TR2. The two types of tape rolls TR1 and TR2 are respectively wound around cores TC1 and TC2 having the same inner diameter and have different widths from each other. Of the two types of tape rolls TR1 and TR2, a first type tape roll TR1 is the widest tape roll that can be attached to a tape roll holding mechanism 100 of the printing apparatus 10.

Of the two types of tape rolls TR1 and TR2, a second type tape roll TR2 is a tape roll having a width smaller than the width of the first type tape roll TR1. Specifically, the width of the first type tape roll TR1 is, for example, 25 mm. As the width of the second type tape roll TR2, various values smaller than the width of the first type tape roll TR1 like 12 mm, 18 mm, 24 mm, and the like can be adopted. Tape rolls that can be attached to the printing apparatus 10 and that have various widths smaller than the width of the first type tape roll TR1 will be collectively referred to as the second type tape roll TR2.

The tape rolls TR1 and TR2 are so-called linerless tape with no release paper. A heat sensitizing agent is applied to one surface of tape of each of the tape rolls TR1 and TR2. The heat sensitizing agent on the tape forms a color as the heat sensitizing agent is heated. When a portion of the heat sensitizing agent on the tape forms a color, an image such as a character, a symbol, or a figure is printed on the tape. An adhesive is applied to the other surface of the tape. As a result, the approximately cylindrical or columnar shape of the tape can be maintained in a state where the tape is wound around the cores TC1 and TC2, and tape that is drawn out from the tape rolls TR1 and TR2 and on which an image is printed can be affixed to another object.

The printing apparatus 10 includes the tape roll holding mechanism 100, a head 200, a transportation mechanism 300, a lid portion 400, a cutter 500, a controller 600, and a communication section 690.

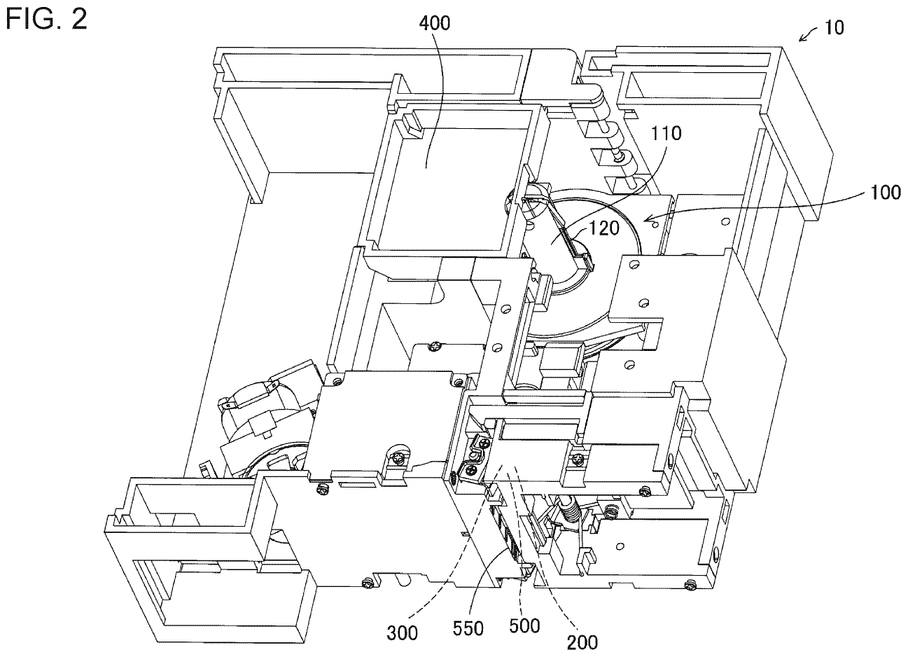

FIG. 2 is a perspective view showing the printing apparatus 10 of the present embodiment. In order to facilitate understanding of the technology, the outer shell of the printing apparatus 10 is not shown in FIG. 2.

A plurality of types of tape rolls TR1 and TR2 are selectively attached to the tape roll holding mechanism 100 and hold the attached tape rolls TR1 and TR2. Specifically, the tape rolls TR1 and TR2 are held by the tape roll holding mechanism 100 with the cores TC1 and TC2, which are tubular, fitted onto a supporting shaft 110 of the tape roll holding mechanism 100.

The tape roll holding mechanism 100 includes a tape holding portion 120 that can be accommodated in the supporting shaft 110. The tape holding portion 120 is pressed by an elastic member in an outward direction from the supporting shaft 110. The tape holding portion 120 includes a protrusion having an inclined surface in a state of protruding from the supporting shaft 110 and a protrusion perpendicularly protruding from the supporting shaft 110.

The first type tape roll TR1 including the core TC1, of which the width is large, is pressed to an end of the supporting shaft 110 with the core TC1 pressing, into the supporting shaft 110, the protrusion of the tape holding portion 120 that has the inclined surface. The first type tape roll TR1 is held by the tape roll holding mechanism 100 in a state where nearly the entire tape holding portion 120 is accommodated in the supporting shaft 110.

Movement of the second type tape roll TR2 including the core TC2, of which the width is small, is restricted by the two protrusions of the tape holding portion 120 that protrude again from the supporting shaft 110 after the second type tape roll TR2 passes through the protrusion of the tape holding portion 120 that has the inclined surface. As a result, the second type tape roll TR2 is held at a position at an intermediate portion of the supporting shaft 110.

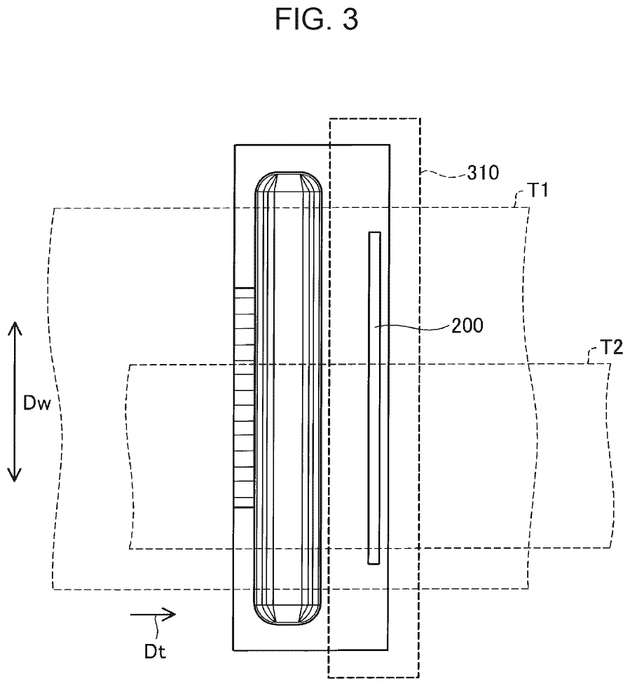

FIG. 3 is a plan view of the head 200. As shown in FIG. 2, the head 200 performs printing on a tape roll attached to the tape roll holding mechanism 100. In FIG. 3, a position where tape T1 of the first type tape roll TR1 is disposed with respect to the head 200 and a position where tape T2 of the second type tape roll TR2 is disposed with respect to the head 200 are respectively represented by means of broken lines. Regarding a width direction Dw of the tape, an area occupied by the head 200 includes the position where the tape T2 of the second type tape roll TR2 is disposed with respect to the head 200. Therefore, the printing apparatus 10 can perform printing, in which no margin is formed at both lateral ends of the tape T2, on the tape T2 of the second type tape roll TR2. Printing in which no margin is formed at both lateral ends of the tape T2 will be referred to as “borderless printing”.

The head 200 includes a plurality of heat generators linearly arranged in a direction perpendicular to a transportation direction Dt in which tape is transported by the transportation mechanism 300. The head 200 protrudes with respect to a structure in the vicinity of the head 200. When tape passes through a space above the protruding head 200 in a state of being in contact with the head 200, the plurality of heat generators selectively generate heat, so that an image such as a character, a symbol, or a figure is printed on the tape.

As shown in FIG. 2, the transportation mechanism 300 draws out tape from an attached tape roll and transports the tape to the head 200. The transportation mechanism 300 includes a platen roller 310. The platen roller 310 is disposed at a position at which the platen roller 310 faces the head 200. The platen roller 310 presses the tape against the head 200 while transporting the tape. As a result, the tape is effectively heated by each of the heat generators of the head 200.

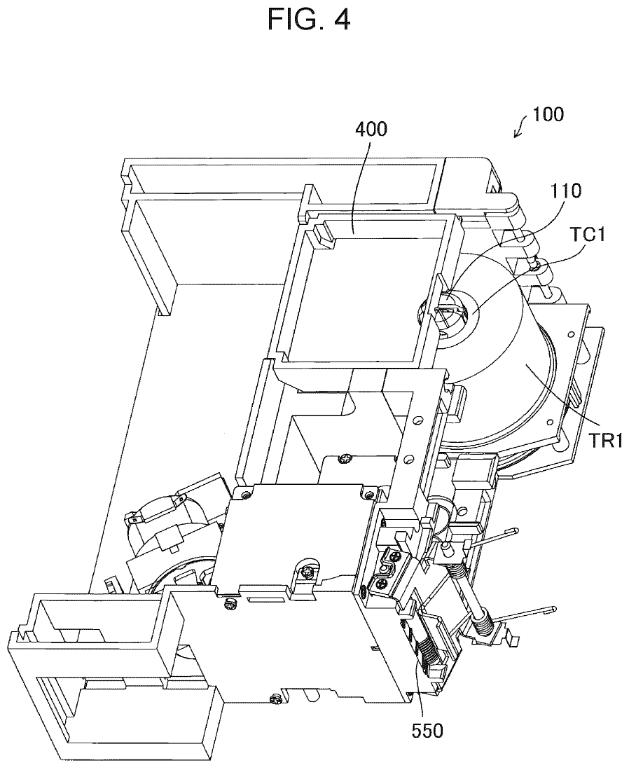

FIG. 4 is an enlarged perspective view showing a configuration in the vicinity of the tape roll holding mechanism 100. In a state as shown in FIG. 4, the first type tape roll TR1 is attached to the tape roll holding mechanism 100. The lid portion 400 is provided in the printing apparatus 10 to be detachable. The lid portion 400 has a function of fixing the position of the first type tape roll TR1 with respect to the tape roll holding mechanism 100 by coming into contact with a lateral end surface of the first type tape roll TR1 attached to the tape roll holding mechanism 100.

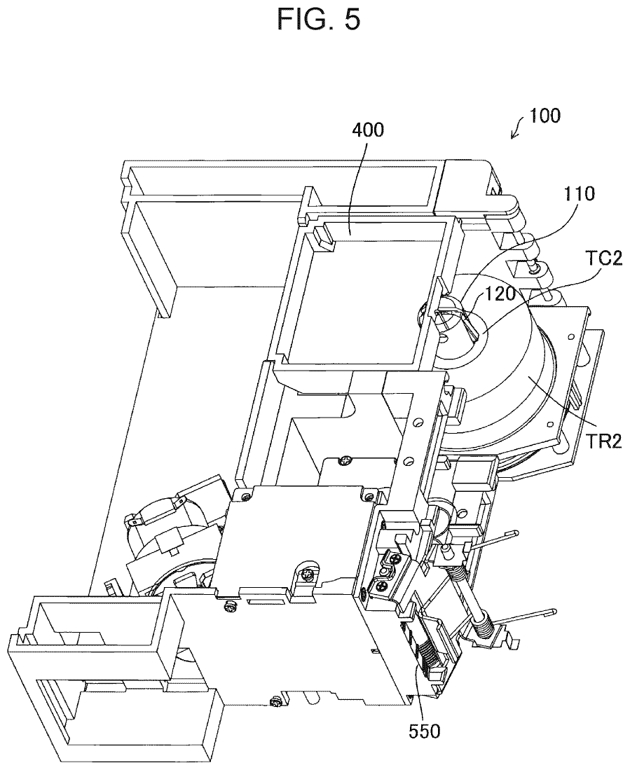

FIG. 5 is an enlarged perspective view showing a configuration in the vicinity of the tape roll holding mechanism 100. In a state as shown in FIG. 5, the second type tape roll TR2 is attached to the tape roll holding mechanism 100. When the second type tape roll TR2 is attached to the tape roll holding mechanism 100, the lid portion 400 is not in contact with the second type tape roll TR2.

The cutter 500 cuts off tape subjected to printing performed by the head 200 from tape not subjected to the printing performed by the head 200. The cutter 500 is a manual cutter. The cutter 500 includes two blades disposed to face each other. Tape subjected to printing performed by the head 200 is transported through a space between the two blades of the cutter 500 and is discharged to the outside of the printing apparatus 10 through a tape discharge port 550. When a user performs an operation such that one of the two blades of the cutter 500 approaches the other of the two blades and the two blades come into contact with each other, the tape subjected to the printing performed by the head 200 is cut off from subsequent tape.

The controller 600 controls the printing apparatus 10. The controller 600 includes a CPU 610 which is a processor, a RAM 620, and a ROM 630. The RAM 620 includes a main storage section and an auxiliary storage section. The RAM 620 is a semiconductor memory. The CPU 610 realizes various functions for control of the printing apparatus 10 by loading a computer program stored in the auxiliary storage section into the main storage section and executing the computer program.

As shown in FIG. 1, the communication section 690 communicates with the information processing apparatus 60. More specifically, the communication section 690 communicates with the information processing apparatus 60 via short-range wireless communication. The controller 600 performs printing on tape of the tape rolls TR1 and TR2 based on information received via the communication section 690.

The information processing apparatus 60 transmits data to the printing apparatus 10 to cause the printing apparatus 10 to perform printing. The information processing apparatus 60 generates information used to cause the printing apparatus 10 to perform printing. Specifically, the information processing apparatus 60 is a smartphone. The information processing apparatus 60 includes an input section 700, a controller 800, and a communication section 900.

The input section 700 receives information from the outside. The input section 700 displays a character and an image. Specifically, the input section 700 is a liquid crystal display including a touch panel. In the input section 700, the liquid crystal panel and the touch panel are arranged to overlap with each other.

The controller 800 controls the information processing apparatus 60. The controller 800 includes a CPU 810 which is a processor, a RAM 820, and a ROM 830. The RAM 820 includes a main storage section and an auxiliary storage section. The RAM 820 is a semiconductor memory. The CPU 810 realizes various functions for control of the information processing apparatus 60 by loading a computer program stored in the auxiliary storage section into the main storage section and executing the computer program. The functions realized by the computer program executed by the CPU 810 will be described later with reference to a flowchart.

As shown in FIG. 1, the communication section 900 communicates with the printing apparatus 10. More specifically, the communication section 900 communicates with the communication section 690 of the information processing apparatus 60 via short-range wireless communication. The controller 800 generates information used to cause the printing apparatus 10 to perform printing based on information received via the communication section 900, and causes the printing apparatus 10 to perform printing on tape of the tape rolls TR1 and TR2.

### A2. Process in Printing System

### 1 Printing Without Background Pattern

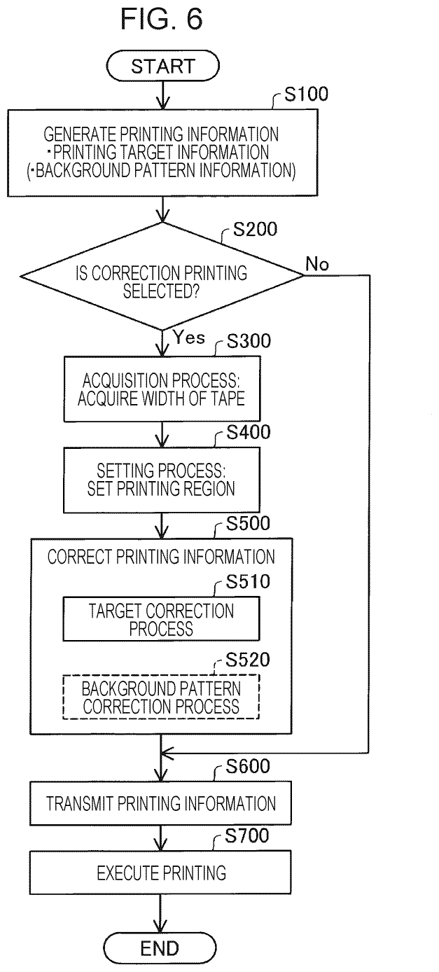

FIG. 6 is a flowchart showing a process in the printing system 1. A method of generating information used to cause the printing apparatus 10 to perform printing is realized by the process in FIG. 6. Hereinafter, first, a process performed at the time of printing without a background pattern will be described. A background pattern will be described later.

In step S100, the controller 800 of the information processing apparatus 60 generates printing information Ip. Specifically, a user operates the input section 700 to select the content to be printed on tape, so that the printing information Ip is generated.

The printing information Ip includes printing target information Ipc. The printing target information Ipc is information representing a target Ch to be printed on tape TP of a tape roll attached to the tape roll holding mechanism 100. The target Ch to be printed on the tape is a set of characters, figures, symbols, and the like, each having a finite height and width. The printing target information Ipc includes information on the dimensions and position of the target Ch reproduced on the tape TP.

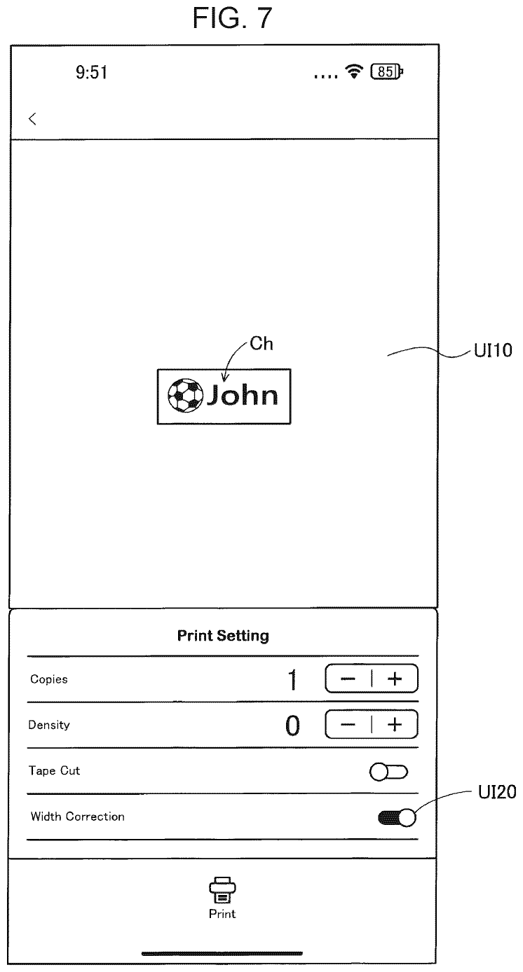

FIG. 7 is a diagram showing a screen displayed on the input section 700 in step S100 of FIG. 6. A user interface UI10 and a user interface UI20 are displayed on the input section 700.

The content to be printed on the tape is shown in the user interface UI10. The content is displayed in the user interface UI10 based on the generated printing information Ip. In an example shown in FIG. 7, a pictogram of a soccer ball and a character string of “John” are displayed.

The user interface UI20 is a toggle button indicating whether or not correction printing will be executed. In the correction printing, correction for a dimension in the width direction Dw of the tape is executed with respect to the printing target information Ipc.

When the second type tape roll TR2 is attached to the tape roll holding mechanism 100, the positional shifting may occur in the width direction Dw of the tape in the transport of the tape by the transportation mechanism 300. When the tape is shifted to the outside of an area in which printing is scheduled to be performed by the head 200, a portion of the content to be printed is not printed on the tape. When a user wants to lower a probability that such a situation occurs, the user turns on the user interface UI20 of the input section 700 to select execution of the correction printing after the printing information Ip is generated.

That is, a case where the correction printing is executed is a case where the following conditions (i) and (ii) are satisfied. (i) The second type tape roll TR2 of which the width is smaller than the width of the first type tape roll TR1, which is the widest tape roll that can be attached to the tape roll holding mechanism 100, is attached to the tape roll holding mechanism 100. (ii) An instruction indicating that correction regarding a dimension in the width direction Dw of the tape is to be performed with respect to the printing target information Ipc representing the target Ch to be printed on the tape T2 of the tape roll TR2 attached to the tape roll holding mechanism 100 is received by the information processing apparatus 60 via the input section 700.

After the user checks the content displayed in the user interface UI10 and operates the user interface UI20 as necessary, the user taps a “Print” button displayed in the lowermost section of the screen in FIG. 7.

In step S200 of FIG. 6, the controller 800 determines whether or not the correction printing is selected. When the correction printing is not selected, the process proceeds to step S600. For example, when a user considers a fact that the target Ch to be printed on the tape is to be printed with a large size as more important than a risk that a portion of the content to be printed may not be printed on the tape, the correction printing is not selected. When the correction printing is selected, the process proceeds to step S300.

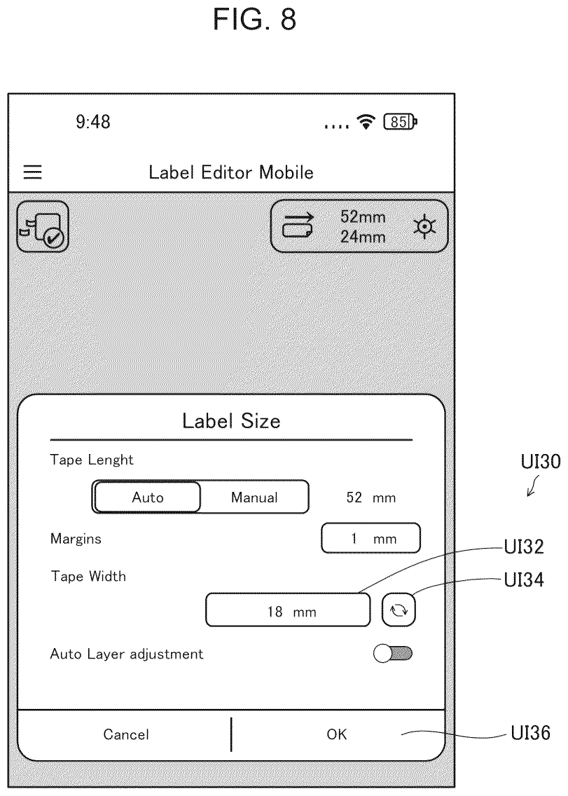

FIG. 8 is a diagram showing a screen displayed on the input section 700 when the width of tape attached to the tape roll holding mechanism 100 is designated. A user interface UI30 is displayed on the input section 700. The user interface UI30 is a user interface used to designate the width of the tape attached to the tape roll holding mechanism 100. The user interface UI30 includes a user interface UI32, a user interface UI34, and a user interface UI36.

In step S300, the controller 800 executes an acquisition process. In the acquisition process, a width Wt of the tape T2 of the attached tape roll TR2 is acquired via the input section 700.

The user interface UI32 is a user interface representing tape width designated at that time. In an example shown in FIG. 8, “18 mm” is designated as the tape width. The user interface UI34 is a user interface used to change the designated tape width. When the user wants to input a tape width different from the tape width designated at that time, the user taps the user interface UI32.

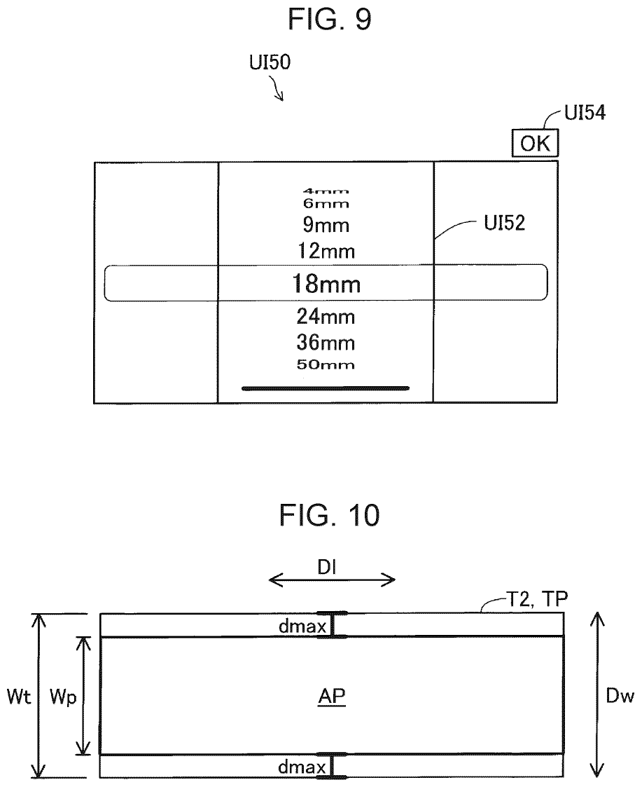

FIG. 9 is a diagram showing a screen displayed on the input section 700 when the user interface UI32 is tapped. When the user interface UI32 is tapped, a user interface UI50 is displayed on the input section 700. The user interface UI50 is a user interface used to designate a tape width. The user interface UI50 includes a user interface UI52 and a user interface UI54.

The user interface UI52 is a user interface used to select a tape width from tape width options. Specifically, the user interface UI52 is a drum roll. In an example shown in FIG. 8, “18 mm” is selected as the tape width. When a user wants to designate a width other than “18 mm” as the tape width, the user rotates the drum roll such that a width that the user wants to designate is disposed in a center frame. The user interface UI54 is a user interface used to determine the tape width displayed on the user interface UI52. When the tape width displayed on the user interface UI52 is to be determined, the user taps the user interface UI54.

When the user interface UI54 is tapped, a screen as shown in FIG. 8 is displayed on the input section 700. When “OK” on the user interface UI36 is tapped in a state where the screen as shown in FIG. 8 is displayed, the designation of the tape width is determined.

In step S400 of FIG. 6, the controller 800 executes a setting process. In the setting process, a printing region AP corresponding to an expected deviation dmax is set. The expected deviation dmax is the maximum expected deviation by which the attached tape roll TR2 is shifted in the width direction Dw with respect to the head 200 in the printing apparatus 10. The expected deviation dmax is substantially constant in the printing apparatus 10 regardless of the width of the tape T2.

FIG. 10 is an explanatory diagram showing a relationship between the tape T2 and the printing region AP. The setting process is a process of setting, as the printing region AP, a region having a width Wp, which is smaller than a width Wt of the tape T2 of the attached tape roll TR2 by two times the maximum expected deviation dmax by which the tape T2 of the attached tape roll TR2 is shifted in the width direction Dw during transportation.

The controller 800 determines the width Wp of the printing region AP based on the following equation.

Wp=Wt−[dmax×2] (1)

Since the process in step S400 is performed, the printing target information Ipc with which it is possible to prevent, with a high probability, the target Ch to be printed from being not printed on tape when the second type tape roll TR2 having a small width is attached to the printing apparatus 10 is generated based on the printing region AP.

In step S500, the controller 800 corrects the printing information Ip. The process that may be performed in step S500 includes a target adjustment process and a background pattern correction process. Description herein is about a process performed when printing without a background pattern is to be performed. Therefore, the background pattern correction process will be described later.

In step S510, the target adjustment process is executed. The target adjustment process includes correction regarding a dimension in the width direction Dw and is performed with respect to the printing target information Ipc. The target adjustment process is executed in accordance with the printing region AP.

In the target adjustment process, information in the printing target information Ipc that is about dimensions that a set Ch of characters or the like to be printed has when the set Ch of characters is reproduced on the tape T2 is corrected. Specifically, a dimension in the width direction Dw of the tape and a dimension in a longitudinal direction Dl of the tape that the set Ch of characters or the like to be printed has when the set Ch of characters is reproduced on the tape T2 are multiplied by [Wp/Wt]. “Wt” is the width of the tape T2. “Wp” is the width of the printing region AP. That is, in the target adjustment process, the aspect ratio of an image such as a character, a symbol, or a figure to be printed is maintained.

Furthermore, information in the printing target information Ipc that is about a position at which a set of characters or the like to be printed is when the set of characters is reproduced on the tape T2 may be corrected in the target adjustment process.

At the time of horizontal printing, correction is performed such that a lower end of the set Ch of characters to be printed is raised by dmax. The “horizontal printing” is printing in which a character string is printed such that upright characters are arranged in a horizontal direction on an assumption that the width direction Dw of the tape TP is a vertical direction.

At the time of vertical printing, the position of the set Ch of characters or the like to be printed is not corrected. The “vertical printing” is printing in which a character string is printed such that upright characters are arranged in the vertical direction on an assumption that the longitudinal direction Dl of the tape TP is the vertical direction.

In step S600 of FIG. 6, the controller 800 transmits the printing information Ip including the printing target information Ipc to the printing apparatus 10 via the communication section 900.

In step S700, the printing apparatus 10 receives the printing information Ip from the controller 800 and executes printing based on the printing information Ip including the printing target information Ipc.

When printing of the target Ch ends, the controller 600 of the printing apparatus 10 ends transportation of the tape TP that is performed by the transportation mechanism 300. The controller 600 starts and ends, based on the printing target information Ipc received from the information processing apparatus 60, transportation of tape that is performed by the transportation mechanism 300. Thereafter, the user operates the cutter 500 to cut off tape subjected to printing performed by the head 200 from tape not subjected to the printing performed by the head 200.

Since the processes of step S300 to step S700 in FIG. 6 are performed, the printing target information Ipc can be corrected in accordance with the width of the tape roll TR2 actually attached to the tape roll holding mechanism 100.

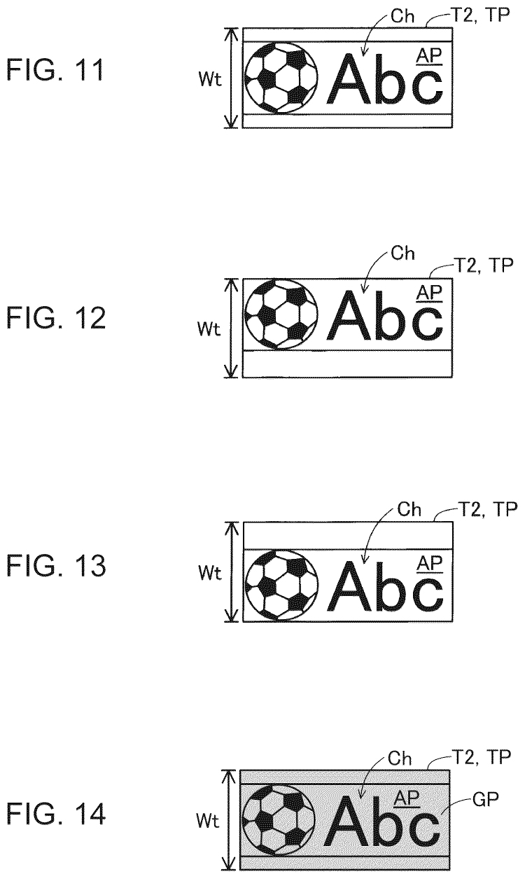

FIGS. 11 to 13 are explanatory diagrams showing the target Ch printed on the tape T2. In order to facilitate understanding of the technology, in FIGS. 11 to 13, an outer edge of the printing region AP is represented by solid lines above and below the target Ch. Regarding the result of printing, the outer edge of the printing region AP is not printed in practice.

FIG. 11 is an explanatory diagram showing the target Ch printed at an ideal position on the tape T2. In an example shown in FIG. 11, margins corresponding to the maximum expected deviation dmax are formed above and below the printed target Ch.

FIG. 12 is an explanatory diagram showing how the result of printing of the target Ch is when the tape T2 is transported with the tape T2 being shifted to one side with respect to the head 200 by the maximum expected deviation dmax. In an example shown in FIG. 12, a margin of which the size is two times the maximum expected deviation dmax is formed below the printed target Ch.

FIG. 13 is an explanatory diagram showing how the result of printing of the target Ch is when the tape T2 is transported with the tape T2 being shifted to the other side with respect to the head 200 by the maximum expected deviation dmax. In an example shown in FIG. 13, a margin of which the size is two times the maximum expected deviation dmax is formed above the printed target Ch.

Since the above-described process is performed, a correction process regarding a dimension in the width direction Dw of the tape is executed in consideration of a positional shift of the second type tape roll TR2 in the width direction Dw of the tape when the second type tape roll TR2 having a small width is attached to the printing apparatus 10. As a result, it is possible to lower a probability that the target Ch to be printed is not printed on tape.

2 Printing with Background Pattern

In step S100 of FIG. 6, the controller 800 of the information processing apparatus 60 generates the printing information Ip. The printing information Ip may include background pattern information Ipg in addition to the printing target information Ipc. The background pattern information Ipg is information representing a background pattern GP that is to be printed on tape of the attached tape roll TR2 to reach both ends of the tape in the width direction Dw. The background pattern GP is printed on the tape TP together with the target Ch in a superimposed manner. The background pattern information Ipg includes information on the dimensions and position of an area within which the background pattern GP is reproduced on the tape TP. A “background pattern” is also called a “background design” or a “background image”.

FIG. 14 is an explanatory diagram showing a case where printing with a background pattern is executed. In order to facilitate understanding of the technology, in FIG. 14, the outer edge of the printing region AP is represented by solid lines above and below the target Ch. Regarding the result of printing, the outer edge of the printing region AP is not printed in practice. In the case of printing with a background pattern, for example, the background pattern GP such as a large number of dots, hatches, and a repeated pattern is printed together with the target Ch to be printed in a superimposed manner.

When the printing information Ip includes the background pattern information Ipg in addition to the printing target information Ipc, step S520 is executed in step S500 of FIG. 6.

In step S520, the background pattern correction process is executed. The background pattern correction process is correction regarding a dimension in the longitudinal direction Dl of the tape and is performed with respect to the background pattern information Ipg. The background pattern correction process is executed in accordance with the printing region AP.

In the background pattern correction process, information in the background pattern information Ipg that is about dimensions of an area within which the background pattern GP is reproduced on the tape T2 is corrected. A dimension of the area, within which the background pattern GP is reproduced on the tape T2, in the longitudinal direction Dl of the tape is multiplied by [Wp/Wt]. “Wt” is the width of the tape T2. “Wp” is the width of the printing region AP. A dimension of the area, within which the background pattern GP is reproduced on the tape T2, in the width direction Dw of the tape is not corrected.

When an area within which the background pattern GP is reproduced on the tape TP is multiplied by [Wp/Wt] in the width direction Dw of the tape, a probability that a region in which the background pattern GP is not printed is formed at an end in the width direction Dw of the tape after printing is increased. However, since the above-described process is performed, a probability that a region in which the background pattern GP is not printed is formed at an end in the width direction Dw of the tape after printing can be lowered.

Regarding the background pattern information Ipg, a dimension, in the width direction Dw, of the area within which the background pattern GP is reproduced on the tape TP is set in advance to be larger than the width Wt of the tape T2 in consideration of the maximum expected deviation dmax. Therefore, even when a dimension of the area within which the background pattern GP is reproduced on the tape T2 is not corrected in the width direction Dw of the tape, a probability that a portion of the background pattern is not printed on the tape is low.

The user can cut off tape, of which transportation is stopped based on the printing target information Ipc subjected to the target adjustment process, from tape not subjected to printing at an appropriate position by using the cutter 500. In the present embodiment, a dimension, in the longitudinal direction Dl of the tape, of an area within which the background pattern GP is reproduced on the tape T2 is multiplied by [Wp/Wt], as with dimensions that the set Ch of characters or the like has when the set Ch of characters is reproduced on the tape T2. Therefore, a probability that there is a background pattern printed on the tape TP remaining after the cutting of the tape TP can be lowered.

According to the printing system 1 of the present embodiment described above, a correction process regarding a dimension in the width direction Dw of the tape is executed in consideration of a positional shift of the second type tape roll TR2 in the width direction Dw of the tape when the second type tape roll TR2 having a small width is attached to the printing apparatus 10. As a result, the printing target information Ipc having the following effects regarding the inexpensive printing apparatus 10 that does not have a complicated configuration for fixation of the position of a tape roll is generated. That is, the printing target information Ipc with which it is possible to lower a probability that the target Ch to be printed is not printed on tape is generated.

### B. Second Embodiment

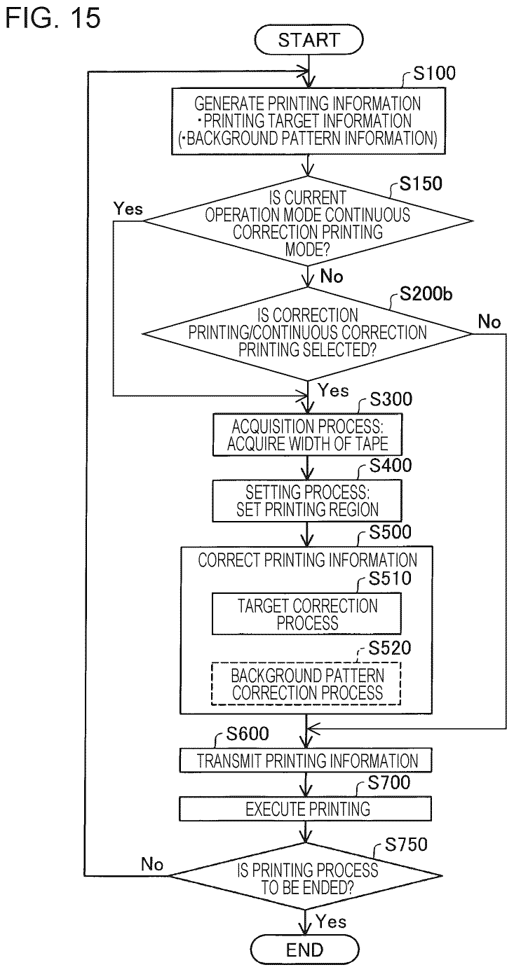

FIG. 15 is a flowchart showing a process in the printing system 1 according to a second embodiment. The process in the printing system 1 of the second embodiment includes step S150 and step S200b instead of step S200 in FIG. 6. The process in the printing system 1 of the second embodiment further includes step S750 after step S700 of FIG. 6. Other points of the process in the printing system 1 of the second embodiment are the same as those of the printing system 1 of the first embodiment.

In step S150, the controller 800 determines whether or not the current operation mode is a continuous correction printing mode. The continuous correction printing mode will be described later. When the current operation mode is the continuous correction printing mode, the process proceeds to step S300. When the current operation mode is not the continuous correction printing mode, the process proceeds to step S200b.

In step S200b, the controller 800 receives, as an instruction, selections of (a) or (b) as follows via the input section 700.
(a) Whether or not the target adjustment process is to be executed only for the printing target information Ipc to be printed next on tape of the attached tape roll TR2.
(b) Whether or not the target adjustment process is to be executed not only for the printing target information Ipc to be printed next but also the printing target information Ipc to be printed thereafter.

In step S200b, on the input section 700, an additional toggle button indicating whether or not continuous correction printing will be executed is displayed in the lowermost section in addition to the user interfaces UI10 and UI 20 in FIG. 7. The additional toggle button is a button used to input the selection of (b). When the toggle button is turned on, the operation mode transitions to a continuous correction printing mode. In the continuous correction printing mode, correction printing is executed without the process of step S200b.

Note that a button used to input the selection of (a) is the user interface UI20. In this case, the user interface UI20 cannot be turned on when the additional toggle button is turned on. Meanwhile, when the user interface UI20 is turned on, the additional toggle button cannot be turned on. That is, the additional toggle button and the user interface UI20 are selectively turned on. When the user interface UI20 is turned on or the additional toggle button is turned off in the case of the continuous correction printing mode, the continuous correction printing mode ends.

In step S750, the controller 800 determines whether or not to end a printing process. Specifically, a question about whether or not to end the printing process, a Yes response button, and a No response button are displayed on the input section 700 of the information processing apparatus 60. When the user does not want to end the printing process, the user taps the No response button. When the No response button is tapped, the process returns to step S100. When the user wants to end the printing process, the user taps the Yes response button. When the Yes response button is tapped, the process ends.

In the second embodiment, when a user desires that printing, in which a probability that the target Ch to be printed is not printed on tape is lowered, is performed on a plurality of the printing targets Ch to be printed consecutively, the user does not need to input an instruction indicating that correction is to be performed each time printing is performed.

### C. Other Embodiments

### C1. Another Embodiment 1

1. In the above-described embodiment, a tape width is selected from tape width options through the user interface UI52, which is the drum roll shown in FIG. 9. The tape width options, from which one is selected through the user interface, are not limited to widths of tape rolls actually manufactured. For example, it is possible to prepare, as a tape width option in advance, the width of a tape roll that may be manufactured in the future. In addition, when a tape roll having a width that is not prepared as a tape width option is newly manufactured, software can be updated so that a controller can execute a target adjustment process and a background pattern correction process corresponding to the new tape roll. Furthermore, the width of tape may be acquired as a user inputs a numerical value via the input section 700 of the information processing apparatus 60.

2. In the above-described embodiment, in step S300 of FIG. 6, the controller 800 executes the acquisition process. In the acquisition process, the width Wt of the tape T2 of the attached second type tape roll TR2 is acquired via the input section 700. However, the controller of the information processing apparatus 60 also can acquire tape width information from the printing apparatus 10 via the communication section of the information processing apparatus. The printing apparatus 10 may include a measuring device that measures the width of tape. In addition, a core of tape may have a shape, a pattern, a color, or the like corresponding to the width of the tape and the printing apparatus 10 may read the shape, the pattern, or the color of the core of the tape and transmit information corresponding thereto to the information processing apparatus 60. The information processing apparatus 60 may determine the width of the tape based on the information received from the printing apparatus 10.

3. In the above-described embodiment, in step S510 of FIG. 6, both a dimension in the width direction Dw of the tape and a dimension in the longitudinal direction Dl of the tape that the set Ch of characters or the like to be printed has when the set Ch of characters is reproduced on the tape T2 are multiplied by [Wp/Wt]. However, a dimension in the longitudinal direction Dl of the tape that is included in the printing target information Ipc may not be corrected. In such a case, a dimension of a printing area in the longitudinal direction Dl of the tape, which is included in the background pattern information Ipg, may not be corrected as well.

4. In the above-described embodiment, in step S520 of FIG. 6, the background pattern correction process is executed. The background pattern correction process is correction regarding a dimension in the longitudinal direction Dl of the tape and is performed with respect to the background pattern information Ipg. However, regarding the information processing apparatus 60, a configuration in which the target adjustment process is executed but the background pattern correction process is not executed can also be adopted.

5. In the above-described embodiment, in step S510 of FIG. 6, the controller 800 determines the width Wp of the printing region AP based on the following equation.

Wp=Wt−[dmax×2] (1)

Here, “Wt” is the width of the tape T2. “dmax” is the maximum expected deviation by which the tape T2 is shifted in the width direction Dw during transportation.

However, the controller 800 can also determine the width Wp of the printing region AP by using another method.

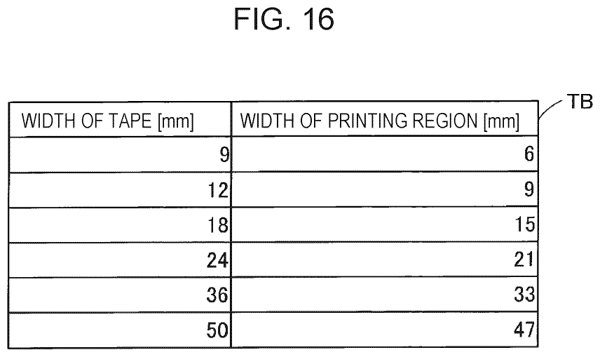

FIG. 16 is a diagram showing a width table TB held by the controller 800. In the present embodiment, the width table TB is stored in advance in the RAM 820 of the controller 800. In FIG. 1, the width table TB is represented by broken lines. The left column of the width table TB is for the width Wt of tape of a tape roll. The right column of the width table TB is for the width Wp of the printing region AP associated with the width Wt of tape. In the case of the widths Wt of tape and the widths Wp of the printing region AP that are shown in the width table TB, the expected deviation dmax shown in FIG. 10 is 1.5 mm. The controller 800 may determine the width Wp of the printing region AP by referring to the width table TB, based on the width Wt of tape that is input by a user.

6. The information processing apparatus 60 may be configured to be able to cause a plurality of types of the printing apparatuses 10 to perform printing. The plurality of types of printing apparatuses 10 are printing apparatuses of which the transportation mechanisms 300 that transport the tape TP of attached tape rolls are different from each other. The printing apparatuses 10 of which mechanisms for tape transportation are different from each other are likely to be different from each other in deviation of tape to be transported.

In such a case, it is preferable that the controller 800 of the information processing apparatus 60 receives model information Itp indicating the type of the printing apparatus 10 from a user via the input section 700 and executes the target adjustment process in accordance with the type of the printing apparatus indicated by the model information Itp. In FIG. 1, the model information Itp is represented by broken lines. For example, the controller 800 may hold a plurality of the width tables TB respectively associated with the types of the printing apparatuses 10. The controller 800 can determine, based on the type of the printing apparatus 10 indicated by the model information Itp input thereto, the width table TB to be referred to and can refer to the determined width table TB to determine, based on the width Wt of tape input thereto, the width Wp of the printing region AP.

The positional deviation of the second type tape roll TR2 in the width direction Dw of the tape differs depending on the type of the printing apparatus 10, the printing apparatuses 10 having different mechanisms for tape transportation. In the above-described case, the target adjustment process is executed in accordance with the type of the printing apparatus 10, so that the printing target information Ipc with which it is possible to lower a probability that the target Ch to be printed is not printed on tape is appropriately generated for each printing apparatus type.

Regarding the information processing apparatus 60, the controller 800 may hold, instead of the plurality of width tables TB, a deviation table of expected deviations dmax associated with the types of the printing apparatuses 10. In such a case, the controller 800 refers to the deviation table to determine the expected deviation dmax based on the type of the printing apparatus 10 indicated by the model information Itp input thereto and determines the width Wp of the printing region AP by using the equation (1) as above.

7. In the above-described embodiment, the communication section 690 of the printing apparatus 10 communicates with the information processing apparatus 60 via short-range wireless communication. However, the printing apparatus 10 and the information processing apparatus 60 may communicate with each other via a mobile phone network or communicate with each other via a satellite line. Furthermore, the printing apparatus 10 and the information processing apparatus 60 may communicate with each other via a wired connection.

8. In the above-described embodiment, the information processing apparatus 60 is specifically a smartphone. However, the information processing apparatus 60 may be, for example, a personal computer, a tablet computer, or a server. That is, the information processing apparatus 60 may be a computer capable of communicating with the printing apparatus 10.

### C2. Another Embodiment 2

1. In the above-described embodiment, as the width of the second type tape roll TR2, various values smaller than the width of the first type tape roll TR1 like 12 mm, 18 mm, 24 mm, and the like can be adopted. In addition, in step S300 of FIG. 6, the controller 800 executes the acquisition process. In the acquisition process, the width Wt of the tape T2 of the attached second type tape roll TR2 is acquired via the input section 700.

However, regarding the printing system 1, there may be only one width Wt of the second type tape roll TR2 that can be attached to the printing apparatus 10. In such a case, the acquisition process of step S300 is not performed, and a fixed value that is held as “Wt” in advance by the controller 800 can be used for the setting of the printing region AP.

2. In the above-described embodiment, in step S400, the controller 800 executes the setting process. In the setting process, the printing region AP corresponding to the expected deviation dmax is set. However, a value obtained by multiplying a tape width by a coefficient smaller than 1 may be used as “Wp” regardless of the expected deviation dmax and correction regarding a dimension in the width direction may be performed on the printing target information Ipc.

### C3. Another Embodiment 3

In the above-described embodiment, the setting process is a process of setting, as the printing region AP, a region having the width Wp, which is smaller than the width Wt of the tape T2 of the attached tape roll TR2 by two times the maximum expected deviation dmax by which the tape T2 is shifted in the width direction Dw during transportation. However, the width Wp of the printing region may be determined by subtracting, from a tape width, another value such as a value that is 1 times, 1.5 times, or 2.5 times the expected deviation dmax.

### C 4. Another Embodiment 4

In the above-described second embodiment, the controller 800 receives, as an instruction, a selection of (b) as follows via the input section 700.
(b) Whether or not the target adjustment process is to be executed not only for the printing target information Ipc to be printed next but also the printing target information Ipc to be printed thereafter.

However, regarding the information processing apparatus 60, the selection of (b) described above may not be received as with the first embodiment.

### C5. Another Embodiment 5

1. In the above-described embodiment, the printing information Ip can include the background pattern information Ipg in addition to the printing target information Ipc. That is, the printing system 1 can perform printing with the background pattern GP. However, regarding the printing apparatus 10 and the information processing apparatus 60, a function of printing a background pattern may not be provided.

2. In the above-described embodiment, the printing apparatus 10 includes the cutter 500 manually operated (refer to a lower central portion in FIG. 2). However, the printing apparatus 10 may include an automatic cutter that operates in synchronization with printing. In addition, the printing apparatus 10 may not include a cutter that cuts tape.

### C6. Another Embodiment 6

In the other Embodiment 1, the information processing apparatus 60 can cause the plurality of types of printing apparatuses 10 to perform printing. However, the information processing apparatus 60 can also be configured as an additional device for a printing apparatus that can cause only one type of printing apparatus 10 to perform printing.

### D. Other Aspects

The present disclosure is not limited to the above-described embodiments, and can be realized in various forms within the scope not departing from the concept of the present disclosure. For example, the present disclosure can also be realized in forms as follows. For example, technical features in the embodiments corresponding to technical features in each aspect described below can be replaced or combined as appropriate to solve some or all of the problems of the present disclosure, or to achieve some or all of the effects of the present disclosure. In addition, unless the technical features are described as essential in the present specification, deletion is possible as appropriate.

1. According to an aspect of the present disclosure, there is provided an information processing apparatus generating information used to cause a printing apparatus to perform printing. The printing apparatus includes a tape roll holding mechanism to which a plurality of types of tape rolls wound around cores having inner diameters determined in advance and having different widths are selectively attached and that holds an attached tape roll and a head that performs printing on tape of the attached tape roll. The information processing apparatus includes an input section for reception of information, a communication section that communicates with the printing apparatus, and a controller that controls the information processing apparatus. The controller executes, with respect to printing target information representing a target to be printed on the tape of the tape roll attached to the tape roll holding mechanism, a target adjustment process including correction regarding a dimension in a width direction of the tape when (i) a second type tape roll having a width smaller than a width of a first type tape roll, which is a widest tape roll attachable to the tape roll holding mechanism, is attached to the tape roll holding mechanism and (ii) an instruction to perform the correction with respect to the printing target information is received via the input section.

In such a case, a correction process regarding a dimension in the width direction of the tape is executed in consideration of a positional shift of the second type tape roll in the width direction of the tape when the second type tape roll having a small width is attached to the printing apparatus. As a result, the printing target information with which it is possible to lower a probability that the target to be printed is not printed on tape is generated.

2. In the information processing apparatus according to the above-described aspect, the controller may execute, before the target adjustment process, an acquisition process of acquiring a width of the attached tape roll via at least one of the input section and the communication section, and a setting process of setting a printing region in accordance with a maximum expected deviation by which the tape of the attached tape roll is shifted with respect to the head in the width direction in the printing apparatus, the target adjustment process may be a process of executing, with respect to the printing target information, the correction in accordance with the printing region, and the controller may transmit the printing target information to the printing apparatus via the communication section to cause the printing apparatus to execute printing based on the printing target information.

In such a case, the printing target information can be corrected in accordance with the width of a tape roll actually attached to the tape roll holding mechanism.

3. In the information processing apparatus according to the above-described aspect, the setting process may be a process of setting, as the printing region, a region having a width that is smaller than the width of the attached tape roll by two times the maximum expected deviation.

In such a case, the printing target information with which it is possible to prevent, with a high probability, the target to be printed from being not printed on tape when the second type tape roll having a small width is attached to the printing apparatus can be generated.

4. In the information processing apparatus according to the above-described aspect, the controller may receive a selection about whether or not to execute the target adjustment process for printing target information to be printed next on the tape of the attached tape roll without executing the target adjustment process for printing target information to be printed thereafter and a selection about whether or not to execute the target adjustment process not only for the printing target information to be printed next but also the printing target information to be printed thereafter, as the instruction via the input section before execution of the target adjustment process.

In such a case, when a user desires that printing, in which a probability that the target to be printed is not printed on tape is lowered, is performed on a plurality of the printing targets to be printed consecutively, the user does not need to input an instruction to perform correction each time printing is performed.

5. In the information processing apparatus according to the above-described aspect, the printing apparatus may include a transportation mechanism that draws out the tape from the attached tape roll and that transports the tape to the head, and a manual cutter that cuts off tape subjected to printing performed by the head from tape not subjected to the printing performed by the head, and when the target adjustment process is performed, the controller may stop, based on the printing target information subjected to the target adjustment process, tape transportation performed by the transportation mechanism without performing the correction regarding the dimension in the width direction with respect to background pattern information that represents a background pattern to be printed on the tape of the attached tape roll to reach both ends of the tape in the width direction and that represents the background pattern to be printed on the tape together with the target in a superimposed manner.

In such a case, a probability that a region in which the background pattern is not printed is formed at an end in the width direction of the tape after printing can be lowered. In addition, a user can cut off tape, of which transportation is stopped based on the printing target information subjected to the target adjustment process, from tape not subjected to printing at an appropriate position by using the cutter.

6. In the information processing apparatus according to the above-described aspect, the controller may be configured to cause a plurality of types of printing apparatuses, of which mechanisms for transportation of tape of attached tape rolls are different, to perform printing, the controller may receive information representing a type of a printing apparatus via the input section, and the controller may execute the target adjustment process in accordance with the type represented by the received information.

The positional deviation of the second type tape roll in the width direction of the tape differs depending on the type of a printing apparatus, the printing apparatuses having different mechanisms for tape transportation. In the above-described case, the target adjustment process is executed in accordance with the type of a printing apparatus, so that the printing target information with which it is possible to lower a probability that the target to be printed is not printed on tape is appropriately generated for each printing apparatus type.

7. According to another aspect of the present disclosure, there is provided an information processing method of generating information used to cause a printing apparatus to perform printing. The printing apparatus includes a tape roll holding mechanism to which a plurality of types of tape rolls wound around cores having inner diameters determined in advance and having different widths are selectively attached and that holds an attached tape roll. The method includes generating printing target information representing a target to be printed on the tape of the tape roll attached to the tape roll holding mechanism, and executing, with respect to the printing target information, a target adjustment process including correction regarding a dimension in a width direction of the tape when (i) a second type tape roll having a width smaller than a width of a first type tape roll, which is a widest tape roll attachable to the tape roll holding mechanism, is attached to the tape roll holding mechanism and (ii) an instruction to perform the correction with respect to the printing target information is received.

8. According to still another aspect of the present disclosure, there is provided a non-transitory computer-readable storage medium storing a computer program causing a computer to generate information used to cause a printing apparatus to perform printing. The printing apparatus includes a tape roll holding mechanism to which a plurality of types of tape rolls wound around cores having inner diameters determined in advance and having different widths are selectively attached and that holds an attached tape roll. The program causes the computer to realize a function of generating printing target information representing a target to be printed on the tape of the tape roll attached to the tape roll holding mechanism, and a function of executing, with respect to the printing target information, a target adjustment process including correction regarding a dimension in a width direction of the tape when (i) a second type tape roll having a width smaller than a width of a first type tape roll, which is a widest tape roll attachable to the tape roll holding mechanism, is attached to the tape roll holding mechanism and (ii) an instruction to perform the correction with respect to the printing target information is received.

The present disclosure may also be realized in various forms other than an information processing apparatus, an information processing method, and a non-transitory computer-readable storage medium storing a computer program. For example, the present disclosure can be realized in the forms of a method for designing an information processing apparatus, a computer program for realizing the method for designing an information processing apparatus, a non-temporary recording medium on which the computer program is recorded, or the like.

What is claimed is:

1. An information processing apparatus generating information used to cause a printing apparatus, which includes a tape roll holding mechanism to which a plurality of types of tape rolls wound around cores having inner diameters determined in advance and having different widths are selectively attached and that holds an attached tape roll and a head that performs printing on tape of the attached tape roll, to perform printing, the information processing apparatus comprising:
an input section for reception of information;
a communication section that communicates with the printing apparatus; and
a controller that controls the information processing apparatus, wherein
the controller executes, with respect to printing target information representing a target to be printed on the tape of the tape roll attached to the tape roll holding mechanism, a target adjustment process including correction regarding a dimension in a width direction of the tape when (i) a second type tape roll having a width smaller than a width of a first type tape roll, which is a widest tape roll attachable to the tape roll holding mechanism, is attached to the tape roll holding mechanism and (ii) an instruction to perform the correction with respect to the printing target information is received via the input section.

2. The information processing apparatus according to claim 1, wherein
the controller executes, before the target p adjustment process,
an acquisition process of acquiring a width of the attached tape roll via at least one of the input section and the communication section, and
a setting process of setting a printing region in accordance with a maximum expected deviation by which the tape of the attached tape roll is shifted with respect to the head in the width direction in the printing apparatus,
the target adjustment process is a process of executing, with respect to the printing target information, the correction in accordance with the printing region, and
the controller transmits the printing target information to the printing apparatus via the communication section to cause the printing apparatus to execute printing based on the printing target information.

3. The information processing apparatus according to claim 2, wherein
the setting process is a process of setting, as the printing region, a region having a width that is smaller than the width of the attached tape roll by two times the maximum expected deviation.

4. The information processing apparatus according to claim 1, wherein
the controller receives a selection about whether or not to execute the target adjustment process for printing target information to be printed next on the tape of the attached tape roll without executing the target adjustment process for printing target information to be printed thereafter and a selection about whether or not to execute the target adjustment process not only for the printing target information to be printed next but also the printing target information to be printed thereafter, as the instruction via the input section before execution of the target adjustment process.

5. The information processing apparatus according to claim 1, wherein
the printing apparatus includes
a transportation mechanism that draws out the tape from the attached tape roll and that transports the tape to the head, and
a manual cutter that cuts off tape subjected to printing performed by the head from tape not subjected to the printing performed by the head, and
when the target adjustment process is performed, the controller stops, based on the printing target information subjected to the target adjustment process, tape transportation performed by the transportation mechanism without performing the correction regarding the dimension in the width direction with respect to background pattern information that represents a background pattern to be printed on the tape of the attached tape roll to reach both ends of the tape in the width direction and that represents the background pattern to be printed on the tape together with the target in a superimposed manner.

6. The information processing apparatus according to claim 1, wherein
the controller is configured to cause a plurality of types of printing apparatuses, of which mechanisms for transportation of tape of attached tape rolls are different, to perform printing,
the controller receives information representing a type of a printing apparatus via the input section, and
the controller executes the target adjustment process in accordance with the type represented by the received information.

7. An information processing method of generating information used to cause a printing apparatus, which includes a tape roll holding mechanism to which a plurality of types of tape rolls wound around cores having inner diameters determined in advance and having different widths are selectively attached and that holds an attached tape roll, to perform printing, the method comprising:
generating printing target information representing a target to be printed on the tape of the tape roll attached to the tape roll holding mechanism; and
executing, with respect to the printing target information, a target adjustment process including correction regarding a dimension in a width direction of the tape when (i) a second type tape roll having a width smaller than a width of a first type tape roll, which is a widest tape roll attachable to the tape roll holding mechanism, is attached to the tape roll holding mechanism and (ii) an instruction to perform the correction with respect to the printing target information is received.

8. A non-transitory computer-readable storage medium storing a computer program causing a computer to generate information used to cause a printing apparatus, which includes a tape roll holding mechanism to which a plurality of types of tape rolls wound around cores having inner diameters determined in advance and having different widths are selectively attached and that holds an attached tape roll, to perform printing, the program causing the computer to realize:
a function of generating printing target information representing a target to be printed on the tape of the tape roll attached to the tape roll holding mechanism; and
a function of executing, with respect to the printing target information, a target adjustment process including correction regarding a dimension in a width direction of the tape when (i) a second type tape roll having a width smaller than a width of a first type tape roll, which is a widest tape roll attachable to the tape roll holding mechanism, is attached to the tape roll holding mechanism and (ii) an instruction to perform the correction with respect to the printing target information is received.
